(19) United States
(12) Patent Application Publication
(10) Pub. No.: US 2020/0125390 A1
(43) Pub. Date: Apr. 23, 2020

(54) APPARATUS AND METHOD FOR HIERARCHICAL CONTEXT AWARENESS AND DEVICE AUTONOMOUS CONFIGURATION BY REAL-TIME USER BEHAVIOR ANALYSIS

(71) Applicant: Electronics and Telecommunications Research Institute, Daejeon (KR)

(72) Inventors: Eun Joo KIM, Daejeon (KR); Jong Arm JUN, Daejeon (KR); Nae Soo KIM, Daejeon (KR); Soon Hyun KWON, Incheon (KR); Seong Ik CHO, Sejong-si (KR); Cheol Sig PYO, Sejong-si (KR)

(73) Assignee: Electronics and Telecommunications Research Institute, Daejeon (KR)

(21) Appl. No.: 16/657,584

(22) Filed: Oct. 18, 2019

(30) Foreign Application Priority Data
Oct. 19, 2018 (KR) 10-2018-0125474

(51) Int. Cl. G06F 9/46; G06F 9/445; G06F 9/38; G06F 11/36; G06N 20/00

(52) U.S. Cl. CPC G06F 9/461; G06F 9/4451; G06N 20/00; G06F 11/3688; G06F 9/3891

(57) ABSTRACT

Provided is an apparatus and method for hierarchically providing a context-aware service by real-time user behavior analysis, autonomously collecting information required for the context-aware service using a smart device, and autonomously configuring the service. The apparatus for hierarchical context awareness and device autonomous configuration through a real-time user behavior analysis includes a fast context aware engine configured to receive user data, infer a context, and provide a primary response context aware service, and a fine context aware engine configured to provide a secondary response context aware service using context information inferred by the fast context aware engine and machine learning prediction data, wherein the fast context aware engine reconfigures a resource of a smart device to suit a service.

### CROSS-REFERENCE TO RELATED APPLICATION

This application claims priority to and the benefit of Korean Patent Application No. 2018-0125474, filed on Oct. 19, 2018, the disclosure of which is incorporated herein by reference in its entirety.

### BACKGROUND

### 1. Field of the Invention

The present invention relates to an apparatus and method for hierarchically providing a context-aware service by real-time user behavior analysis, autonomously collecting information required for the context-aware service using a smart device, and autonomously configuring the service.

### 2. Discussion of Related Art

A context-aware service is a service that recognizes a situation of a user and actively provides the user with the most appropriate and useful information.

According to the related art, various context aware service providing frameworks using ontology modeling have been proposed. However, there is a lack of proposed techniques that can recognize a dynamically changing context and utilize a knowledgebase of various fields.

### SUMMARY OF THE INVENTION

The present invention provides a method of providing an action control/response service in real time through a user behavior analysis in an Internet of Everything (IoE) device, providing a context customized response service by expanding surrounding circumstance data (user's history, social Internet of Things (IoT), domain knowledge, and the like), expanding a sensing range by recognizing an object, a user, and a circumstance by itself, and autonomously reconfiguring an operating environment on the basis of a user's intention and a circumstance.

According to one aspect of the present invention, there is provided an apparatus for hierarchical context awareness and device autonomous configuration through a real-time user behavior analysis, the apparatus including a fast context aware engine configured to receive user data, infer a context, and provide a primary response context aware service and a fine context aware engine configured to provide a secondary response context aware service using context information inferred by the fast context aware engine and machine learning prediction data, wherein the fast context aware engine reconfigures a resource of a smart device to suit a service.

### BRIEF DESCRIPTION OF THE DRAWINGS

FIG. 1 is a conceptual block diagram illustrating a hierarchical context aware engine according to an embodiment of the present invention.

FIG. 2 is a block diagram illustrating a hierarchical context aware engine according to an embodiment of the present invention.

FIG. 3 is a block diagram illustrating a fast context aware engine according to an embodiment of the present invention.

FIG. 4 is a block diagram illustrating a fine context aware engine according to an embodiment of the present invention.

FIG. 5 is a diagram illustrating generation of a learning model and a logic of a machine learning engine according to an embodiment of the present invention.

FIG. 6 is a diagram illustrating real-time analysis and prediction of sensing data of a machine learning engine according to an embodiment of the present invention.

FIG. 7 is a diagram illustrating an input of a knowledgebase and generation of new machine learning prediction data of a machine learning engine according to an embodiment of the present invention.

FIG. 8 illustrates a data flowchart of a fast context aware engine according to an embodiment of the present invention.

FIG. 9 illustrates a data flowchart of a fine context aware engine according to an embodiment of the present invention.

FIG. 10A and FIG. 10B illustrate data flowcharts of a machine learning engine according to an embodiment of the present invention.

FIG. 11 is a block diagram illustrating resource discovery and application program deployment of a smart device according to an embodiment of the present invention.

FIG. 12 is a diagram illustrating details of a resource list required for context awareness according to an embodiment of the present invention.

FIG. 13 illustrates an example of application of a resource property and a resource application program according to an embodiment of the present invention.

FIG. 14A and FIG. 14B illustrate data flowcharts of a smart device according to an embodiment of the present invention.

FIG. 15 illustrates a sequence diagram of resource discovery and application program deployment with respect to an external resource according to an embodiment of the present invention.

FIG. 16 is a view illustrating an example of a computer system in which a method according to an embodiment of the present invention is performed.

### DETAILED DESCRIPTION OF EXEMPLARY EMBODIMENTS

Hereinafter, the above and other objectives, advantages and features of the present invention and manners of achieving them will become readily apparent with reference to descriptions of the following detailed embodiments when considered in conjunction with the accompanying drawings.

However, the scope of the present invention is not limited to such embodiments, and the present invention may be embodied in various forms. The embodiments to be described below are embodiments provided only to complete the disclosure of the present invention and assist those skilled in the art in fully understanding the scope of the present invention, and the present invention is defined only by the scope of the appended claims.

Meanwhile, terms used herein are used to aid in the explanation and understanding of the embodiments and are not intended to limit the scope and spirit of the present invention. It should be understood that the singular forms “a,” “an,” and “the” also include the plural forms unless the context clearly dictates otherwise. The terms “comprises,” “comprising,” “includes,” and/or “including,” when used herein, specify the presence of stated features, integers, steps, operations, elements, components and/or groups thereof and do not preclude the presence or addition of one or more other features, integers, steps, operations, elements, components, and/or groups thereof.

Hereinafter, in order to aid those skilled in the art to understand the present invention, the background will be described first, and then the embodiments of the present invention will be described.

In an Internet of Everything (IoE) environment, various pieces of user behavior information may be collected from a smart device that interoperates with various IoE devices, and an activity may be inferred by identifying properties of data. However, in the case of a complex user behavior, machine learning has a low accuracy in inference and is inefficient in considering various patterns for the behavior, therefore leading to low versatility.

In addition, there is a need for a method in which a smart device recognizes surrounding sensors by itself and autonomously reconfigures an operating environment such that users unskilled in information and communication technology (ICT) are easily collect information of surrounding environment sensors required for the smart device to recognize a situation so that an optimum context aware service is provided while minimizing user's involvement.

That is, there is a need for a new technological approach and paradigm for IoE devices in which an IoE device recognizes the circumstances by itself to provide a fast context aware service in real time and autonomously reconfigures the operating environment so that a human's social life is newly transformed through a natural connection between a human and an object in a situation having minimum human involvement.

The present invention is proposed to remove the above-described limitations and proposes a method of providing a two stage hierarchical context aware service through a real-time user behavior analysis by monitoring information of a user using a smart device and external environment information of the user in an IoE environment, and allowing the smart device to autonomously collect information required for the context aware service and configure the service, and an apparatus using the same.

According to the present invention, in order to recognize a user's behavior and provide a context aware service suitable for a user's intention and a surrounding circumstance in an IoE environment, first, an analysis of the user's behavior needs to be performed in real time. In order to satisfy the real time quality, the present invention provides a context awareness in two stages. A smart device may perform a fast context awareness in which a user' behavior is analyzed in real time (a first stage), and a server may provide a fine context awareness using a result from the first stage, surrounding circumstance information, and the like (a second stage).

The provision of a fast context aware service of identifying a user's behavior by the smart device allows a machine learning to consider a personalized pattern, which results in higher accuracy. In addition, the provision of a fast context aware service of identifying a user's behavior by the smart device allows a context aware service to be more rapidly provided to the user and also obviates a need to transmit all the collected sensor data to the server and thus excessive data transmission traffic is prevented and personal privacy issues are reduced to some extent.

In addition, the smart device enables an autonomous operating environment configuration of selectively collecting smart device internal resources and external environmental information resources required for context awareness and of configuring the smart device internal resources and external environmental information resources to suit the service so as to execute an appropriate service according to the context awareness, and thus an optimum context aware service may be provided while minimizing user's involvement.

The server provides a method of using ontology and a method of analyzing data through machine learning for fine context awareness. The fine context awareness may convert collected user behavior information and surrounding environment information into knowledge and use the knowledge for inference, and the fine context awareness may identify user's history/intention to generate a new machine learning analysis result. In addition, the server may generate an inference rule according to the new analysis result.

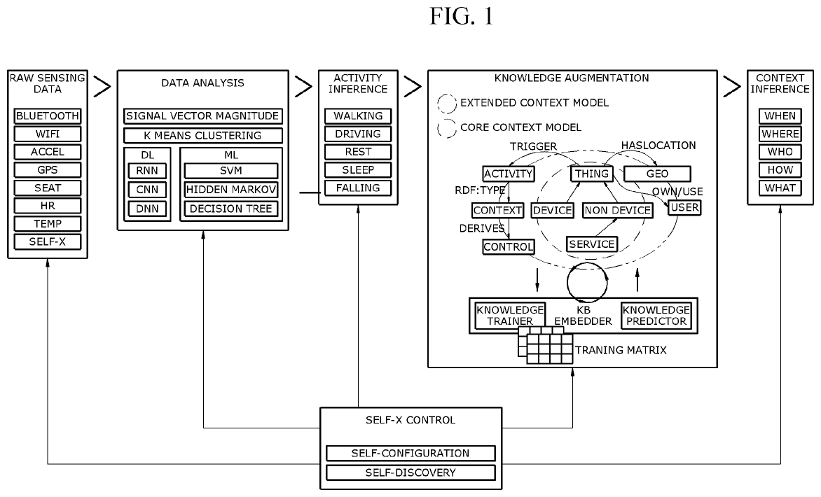

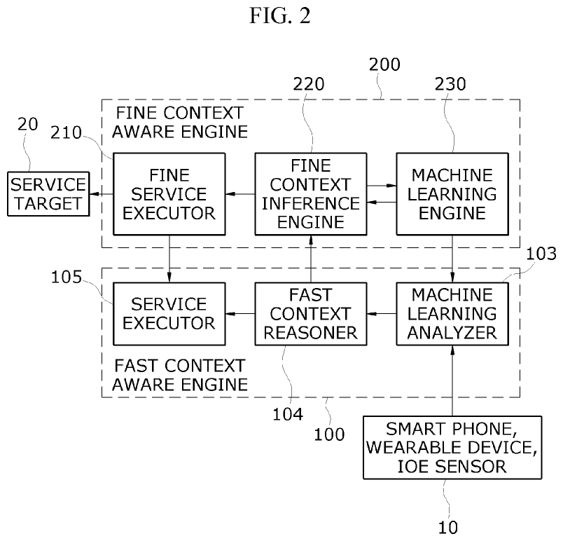

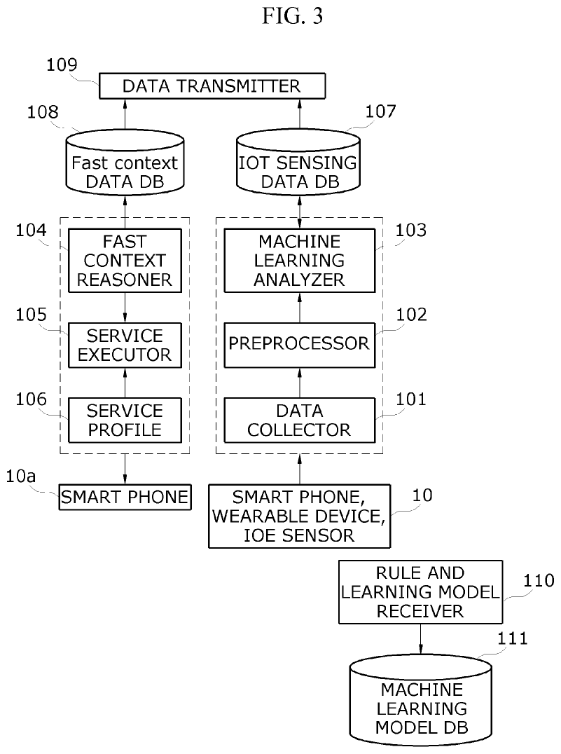

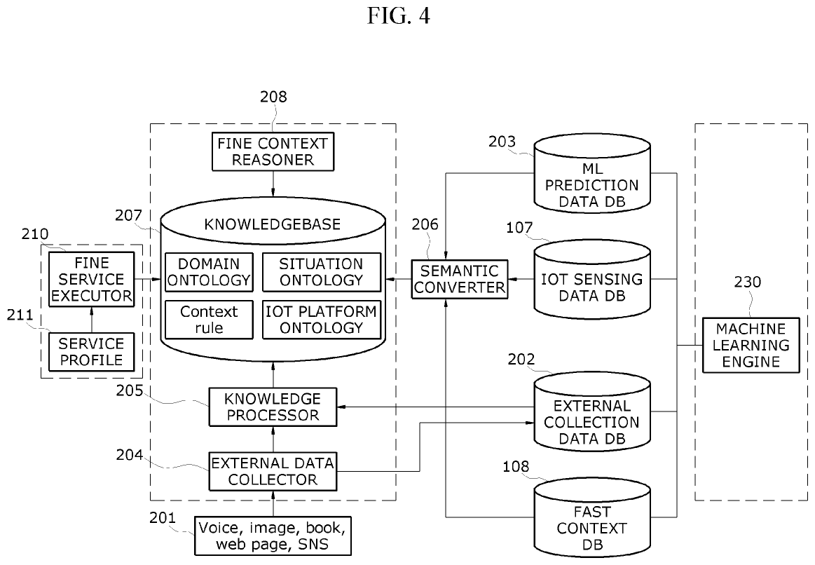

FIG. 1 is a conceptual block diagram illustrating a hierarchical context aware engine according to an embodiment of the present invention. FIG. 2 is a block diagram illustrating a hierarchical context aware engine according to an embodiment of the present invention. FIG. 3 is a block diagram illustrating a fast context aware engine according to an embodiment of the present invention. FIG. 4 is a block diagram illustrating a fine context aware engine according to an embodiment of the present invention.

According to an embodiment of the present invention, context information of a user in an IoE environment is collected and inferred to provide a stepwise response context aware service.

In addition, a device autonomous configuration function is provided such that an appropriate service that suits the user's intention and circumstances is dynamically reconfigured.

The IoE environment includes a wearable device, an IoE device and the like equipped with sensors. A smart device collects sensing information from an internal sensor and a surrounding IoE sensor and infers a user's activity through deep learning/machine learning analysis. A result of the inference is transmitted to a server and thus subject to knowledge modeling and machine learning so that more detailed or a new context is inferred and a context aware service is provided on the basis of the result of inference.

The IoE intelligent context aware service provision is achieved by a series of processes including sensor data collection, analysis, activity inference, knowledge enhancement, context inference, and the like, and in the series of processes, when hardware (H/W) or software (S/W) control of the smart device is needed, the need may be recognized by itself to autonomously reconfigure an operating environment or perform an operation. For example, a connection to a surrounding environment sensor may be automatically achieved so that an operating environment may be reconfigured or an operation of controlling hardware in the smart device may be performed as needed.

The hierarchical context aware engine includes a fast context aware engine 100 for providing a primary response context aware service and a fine context aware engine 200 for providing a secondary response context aware service.

The fast context aware engine 100 according to the embodiment of the present invention includes a machine learning analyzer 103, a fast context reasoner 104, and a service executor 105.

In response to receiving a request for a context aware service of a user, the fast context aware engine 100 first collects pieces of sensing data from the smart device.

When the collected data is subject to a preprocessing process, the machine learning analyzer 103 analyzes the data using an appropriate machine learning model.

A machine learning model database (DB) 111 contains various algorithms on which a learning process is performed in advance, and the model are received from a machine learning engine manager 239 of a server.

After the machine learning data analysis of the machine learning analyzer 103, a fast context is generated through the fast context reasoner 104 and stored in a fast context data DB 108.

The fast context is periodically transmitted to the server (the fine context aware engine) through a data transmitter 109 to provide a secondary response, that is, a fine context aware service.

The sensing data collected from the smart device and a wearable device is stored in an Internet of Things (IoT) sensing data DB 107 and is transmitted periodically to the server (the fine text aware engine) through the data transmitter 109 to be used for fine context aware service provision, real-time machine learning analysis, and prediction.

The service executor 105 detects an event according to the fast context generated as a result of the inference of the fast context reasoner 104 and a service profile 106 and provides a fast context aware service in real time upon occurrence of an abnormal situation.

When an event is detected by the fast context reasoner 104, a fast context is generated, event information is stored in a knowledgebase 207 of the fine context aware engine 200, and a fine context aware service is requested.

The fine context aware engine 200 includes a knowledge-based fine context inference engine 220, a machine learning engine 230, and a fine service executor 210.

Referring to FIG. 4, the fine context inference engine 220 includes a semantic converter 206, an external data knowledge processor 205, a fine context reasoner 208, and a knowledgebase 207.

The semantic converter 206 converts data received from the smart device and machine learning engine data to perform semantic analysis.

The semantic converter 206 performs semantic conversion on context information received from the fast context data DB 108, sensing data received from the IoT sensing data DB 107, and data received from a machine learning (ML) prediction data DB 203.

The fine context reasoner 208 performs inference using an ontology method using data converted through the semantic converter 206, external collection data converted through the external data knowledge processor 205, and the knowledgebase 207.

The knowledgebase 207 includes domain information, a context rule, a context ontology, an IoT platform ontology, and the like.

The machine learning engine 230 generates and tests a machine learning model by allowing external collection data and IoT sensing data to pass through a collector 231, a preprocessor 232, a property extractor 233, and a machine learner 234.

When the existing learning model of the smart device is updated, the machine learning engine manager 239 transmits a new-version learning model to the smart device.

The machine learning engine 230 performs real-time sensing data analysis and prediction using IoT sensing data collected from the smart device.

By using the data predicted as such, the machine learning engine manager 239 transmits a logic, a machine learning model, or the like according to the prediction to the smart device.

The machine learning prediction data may also be used for fine context aware inference.

The fine service executor 210 executes a service inferred by the fine context reasoner 208 using a service profile 211.

The service profile 211 is determined by various combinations of a user, an occupation, a personal medical history, a doctor's note record, a prescription, and the like.

A service target 20 may be a user, a hospital, a doctor, a guardian, a social network service (SNS), a building, various devices, and the like.

For example, when a user enters an art gallery, a smart device of the user detects that a current location is an art gallery through a global positioning system (GPS) and surrounding sensors and automatically changes the sound of the smart device to silent. When the user viewing art works suddenly collapses and cannot rise, the smart device first performs a fast context aware, that is, recognizes the collapsing behavior of the user. When the behavior corresponds to ‘an emergency situation’, the smart device generates an alarm to request help in user's surroundings.

In this case, when the smart device of the user is in a silent mode, no sound is produced even when an alarm service is executed. Accordingly, the smart device changes from a silent mode to a sound mode and provides an alarm service by itself.

After detecting the user's collapsing behavior event, the fine context aware engine 200 uses knowledgebase information including domain knowledge.

For example, when the user is a patient having an experience of having a stroke and there are environmental conditions in which a stroke is highly likely to occur due to a sudden drop in temperature recently, a stroke may be suspected with respect to the situation of the user.

In this case, the situation of the user is classified as an emergency situation, and an emergency rescue team close to the user's current location is urgently contacted, and an acquaintance (nearby friend or family member) registered by the user in advance is also contacted.

As another example, when a user's blood pressure suddenly increases while driving, the smart device primarily detects that the user is driving and his or her blood pressure has increased and provides the user with a guide service instructing the user to stop driving and rest.

When the user collapses after a while, the smart device detects a real-time collapsing behavior (a collapsing event) and transmits emergency situation occurrence information about a fall-down while driving to the fine context aware engine 200.

The fine context aware engine 200 having received the emergency context of the user identifies the user's medical history, the surrounding environment, and the like, provides a notification service to contact an emergency rescue center close to the user, and provides an accident notification service to notify a nearby rescuer through social networks or the like.

As another example, when an accident occurs while driving, the cause of the accident needs to be identified considering various situations such as a situation of the driver, a defect of the vehicle, and a surrounding circumstance of the driving road.

In this case, when the situation of the driver is identifiable in real time, the cause of the accident may be identified, and also a proactive measure may be taken before occurrence of an accident.

In order to perform a behavior analysis of the user, the data collector 101 collects sensing data from the smart device or peripheral devices connected to the smart device.

The collected user information is preprocessed by a preprocessor and is property-extracted and then is transmitted to the machine learning analyzer 103 on which a learning process is performed in advance.

The machine learning analyzer 103 analyzes a sensor value and generates a context information result.

The machine learning analyzer 103 transmits the analysis result to the fast context reasoner 104, and the result is stored as user context information.

When an event is detected according to the inference result, the service executor 105 provides a primary response context aware service.

The fast context aware engine 100, in response to detecting the event, requests the fine context aware engine 200 for a customized context aware service.

The fine context reasoner 208 derives a service using various pieces of information in the knowledgebase 207, such as a user history, social IoT information, environment information, and the like, the fast context information, the IoT sensing data, and the machine learning prediction data.

The fine service executor 210 provides an optimally customized context aware service considering the user and the surrounding situation.

The machine learning engine 230 generates a machine learning model, a rule, and the like using IoT sensing data and external collection data.

The machine learning engine 230 performs machine learning prediction using IoT sensing data of the smart device and transmits the prediction data to the fine context inference engine 220.

The machine learning engine 230 transmits a machine learning model and a rule required by the smart device of the user pursuant to the prediction to the smart device, and the smart device receives the algorithm and the rule through a rule and learning model receiver 110.

The machine learning engine 230 receives input from the knowledgebase 207 of the fine context inference engine 220 to generate new machine learning prediction data. When results analyzed from the fast context aware engine are accumulated in the knowledgebase 207, an analysis of life log, history, and the like of the user may be performed. For example, when a result of a user who has had a stroke (a primary context awareness) and a result that a stroke occurs in wintertime inferred using information on weather, season, location, and the like at that time are accumulated for many years, it may be newly predictable that the user frequently has symptoms of a stroke in wintertime or people in a specific region are likely to have a specific disease.

Hereinafter, the fast context aware engine 100 will be described.

The fast context aware engine 100 collects sensing data from a smart device interworking with a wearable device, an IoE device, and the like and identifies low-level user behaviors using machine learning.

For example, the fast context aware engine 100 collects sensor data of a smart watch connected thereto through Bluetooth and analyzes user's current behavior (walking, running, walking up stairs, walking down stairs, sitting, falling down, etc.). In addition, depending on the situation, the fast context aware engine 100 automatically searches for a surrounding sensor and is connected to the smart device to collects surround circumstance information (altitude, temperature, GPS, seat sensor, etc.) such that the smart device may identify dynamic context information of the user in more detail.

The identified user behaviors are stored as a context of the user by the fast context reasoner 104.

The fast context reasoner 104 detects an event when the behavior of the user is not ordinary, infers which service needs to be provided, and requests a service according to the result of the inference.

The data collector 101 collects all types of sensing information collectable from the smart device including a sensor connected to the smart device (a wearable device, an IoE device with a sensor, etc.) and stores the sensing information in the IoT sensing data DB 107.

The machine learning analyzer 103 identifies a low-level behavior of the user through the data collected from the data collector 101 and preprocessed by the preprocessor 102.

The above-described preprocessing process may be performed by the preprocessor 102. However, as another example, raw IoT sensing data is transferred to the fine context aware engine 200, and the fine context aware engine 200 may perform the pre-processing.

In the machine learning model DB 111, a model for recognizing a simple behavior of a user is pre-learned and stored, and examples of the existing learning model include a machine learning model, such as a hidden Markov model (HMM), a support vector machine (SVM), and an artificial neural network (ANN), and a deep learning model such as recurrent neural network (RNN), convolutional neural network (CNN), and recurrent neural network (DNN). In order to classify a behavior using the deep learning model, raw data is converted into a signal image, and the signal image is converted into a behavior image. In this case, the converted behavior images respectively represent different behaviors, and thus behaviors are classified.

Sensor data of the smart phone, once acquired, is divided into training data and test data for use. In the case of user's behavior analysis, 3-axis (x, y, z) data of an acceleration sensor and a gyro sensor is collected at an interval of 20 to 50 Hz and is pre-processed and sampled. Thereafter, learning is performed using the above described models and test is performed using the test data so that the accuracy of the behavioral analysis may be determined. Since the collected data varies according to the collection location, the collection cycle, and the like of the smartphone, various studies and verification are required to generate a learning model.

In addition, such research is an example of research on machine learning performed in a server, and in the case of machine learning interference performed in a smart phone, a machine learning platform for a mobile terminal needs to be provided. One of the currently available machine learning platforms for Android/iOS is Google's tensorflow-lite published by Google. In order that a model having learned in Tensorflow is used in Tensorflow-lit, a lightweight learning model is needed.

The machine learning model DB 111 does not only include the above-proposed learning model but also include a new model developed for extracting user behavior characteristics and a model trained with a newly proposed compression method.

The fast context reasoner 104 stores context information and, in response to detecting an event with the detected low-level behavior, requests a service to respond to the event.

In this case, a service to be performed among possible services is selected.

The service executor 105 executes the selected service, monitors the service, and requests a service to be performed again in case of a failure.

Hereinafter, the fine context aware engine 200 will be described.

The fine context aware engine 200 interworks with the fast context data DB 108 and the IoT sensing data DB 107 generated by the fast context aware engine 100.

The fine context aware engine 200 collects external data 201, such as a speech, an image, a webpage, a social IoT service (SNS), and the like, and stores the external data 201 in an external collection data DB 202.

The fine context aware engine 200 converts the fast context DB information, the IOT sensing data, and the machine learning prediction data into an appropriate context form (converted data) using the semantic converter 206.

The knowledgebase 207 of the fine context aware engine 200 includes a domain ontology, a context ontology, an IoT platform ontology, converted data, context rules, an inference knowledgebase, and the like.

A context is generated using the machine learning prediction data, the context ontology, the domain ontology, the platform ontology, the context rules, and the converted data. The fine context reasoner 208 provides a user with a fine context-aware service with respect to the context generated using the pieces of information of the knowledgebase 207.

The fine context aware engine 200 performs inference using various types of IoT data including a speech, an image, a social networking service (SNS). The fine context aware engine 200 may not only infer a service corresponding to event detection received from the IoT smart device, but also detect an event in a new situation by itself, predict a service, and provide the service to a user.

That is, the fine context aware engine 200 may derive a new situation and provide a prediction service suitable for the derived new situation.

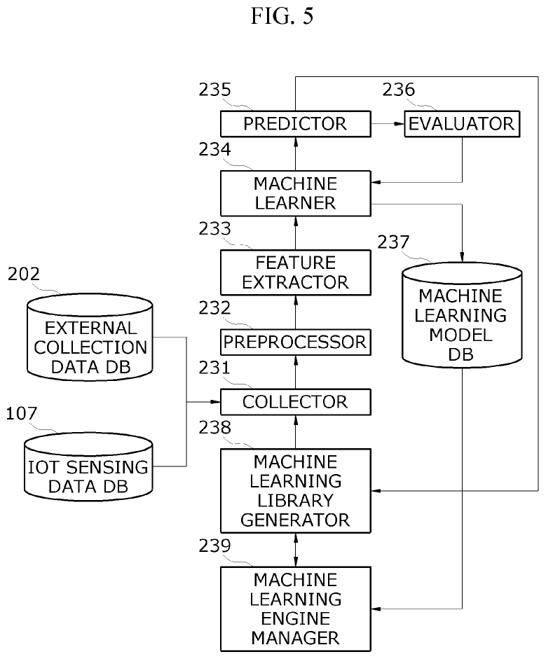

Hereinafter, the machine learning engine 230 will be described with reference to FIGS. 5 to 7.

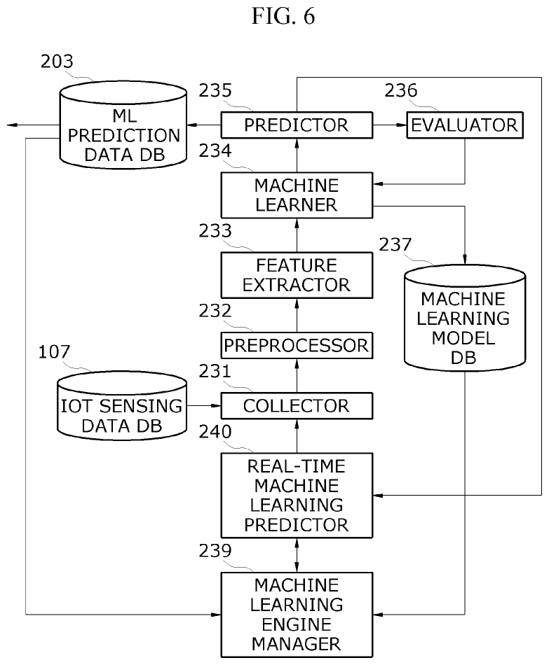

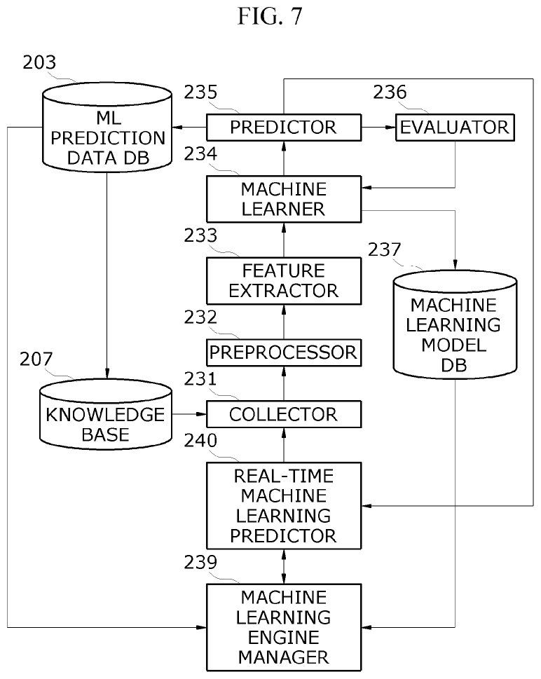

FIG. 5 is a diagram illustrating generation of a learning model and a logic of a machine learning engine according to an embodiment of the present invention. FIG. 6 is a diagram illustrating real-time analysis and prediction of sensing data of a machine learning engine according to an embodiment of the present invention. FIG. 7 is a diagram illustrating an input of a knowledgebase and generation of new machine learning prediction data of a machine learning engine according to an embodiment of the present invention.

Referring to FIG. 5, the machine learning engine 230 collects external collection data collected by the fine context aware engine 200 and IoT sensing data collected by the smart device to perform machine learning training and generates machine learning models and logics.

That is, a machine learning model is first generated using IoT sensing data and external collection data and is stored in a DB. The learning models stored in the DB is to be used for machine learning analysis in the server and the smart device later, and do not need to be real time.

Referring to FIG. 6, the machine learning engine 230 analyzes the IoT sensing data in real time and performs prediction for the next situation, and the corresponding machine learning prediction data is used as a context of fine context aware data. The process may not be necessarily needed and may be replaced by real-time machine learning prediction result from the smart devices.

A real-time machine learning predictor 240 generates a new real-time prediction result using a semantic inference result or an incomplete context aware rule and transmits a learning model, logic, and the like predicted for the future using the data to the smart device.

Referring to FIG. 7, the semantic inference results of the fine context aware engine 200 may be stored in a knowledgebase, the results may be newly analyzed through the machine learning engine 230, and thus new prediction results may be generated.

In addition, referring to FIG. 7, when a knowledge-based context aware rule used in a semantic reasoner of the fine context aware engine 200 is incomplete or does not exist, the knowledge-based context aware rule is generated/added through the machine learning engine 230 and is used.

That is, data of the knowledgebase 207 in the fine context aware engine 200 is input to the machine learning engine 230, and the machine learning engine 230 generates machine learning prediction data.

The learning model and knowledgebase data of the machine learning engine 230 need to be constantly updated, and according to a result of the machine learning predictor, a new machine learning model may be downloaded to the smart device, as needed, or a machine learning model may be downloaded through a rule and learning model receiver 110 at a request of the fast context aware engine 100.

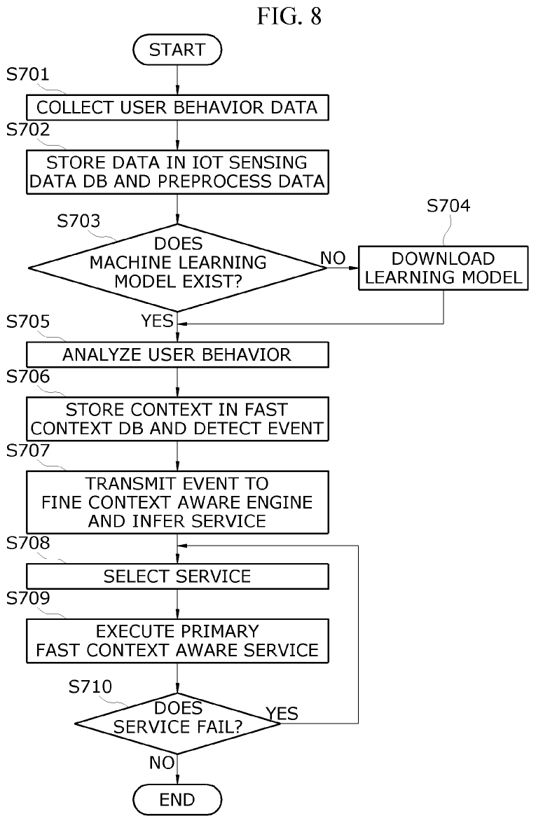

FIG. 8 illustrates a data flowchart of a fast context aware engine according to an embodiment of the present invention.

Sensing data, that is, user behavior data, is collected from a smart device interoperating with a wearable device and an IoE device (S701).

Subsequently, the user behavior data is stored in the IoT sensing data DB, and preprocessing is performed on the data (S702).

Whether a machine learning model exists in the machine learning model DB is checked (S703), an algorithm is downloaded from the machine learning engine manager in response to non-existence of the machine learning model (S704), and the user behavior is analyzed in response to existence of the machine learning model (S705).

Subsequently, a context is stored in the fast context DB, and an event is detected (S706).

The detected event is transmitted to the fine context aware engine, and a service desired by the user is inferred (S707).

When the service is selected (S708), a primary fast context aware service is executed (S709), and whether the service is failed is checked (S710).

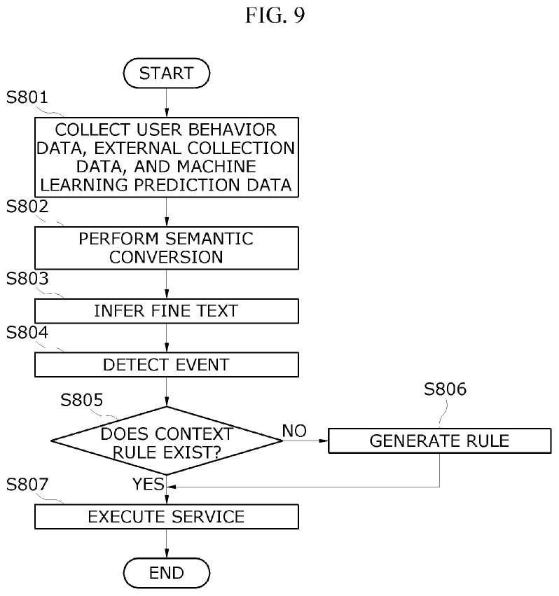

FIG. 9 illustrates a data flowchart of a fine context aware engine according to an embodiment of the present invention.

User behavior data, external collection data, and machine learning prediction data are collected (S801) and converted into an appropriate context form through semantic conversion (S802).

Subsequently, semantic analysis is performed through the fine context reasoner (S803), and an event is detected (S804).

Whether a context rule exists is checked (S805), the rule is generated in response to non-existence of the rule (S806), and a service is executed in response to existence of the rule (S807).

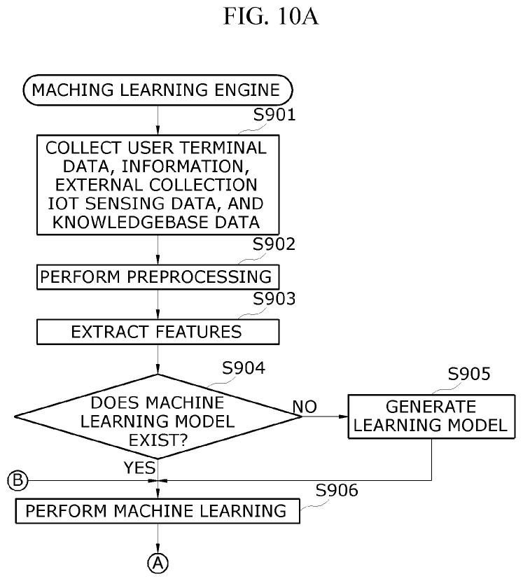

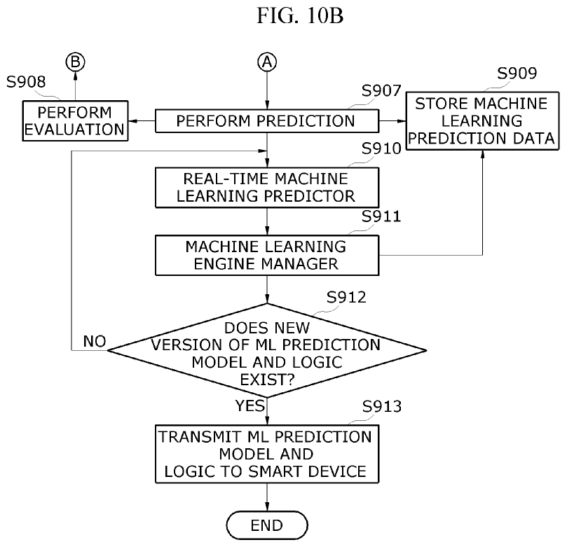

FIG. 10A and FIG. 10B illustrate data flowcharts of a machine learning engine according to an embodiment of the present invention.

User terminal information, external collection data, IoT sensing data, and knowledgebase data are collected (S901).

The knowledgebase includes a domain ontology, a context ontology, an IoT platform ontology, converted data, a context rule, and an inference knowledgebase.

When preprocessing is performed on the data (S902), features are extracted (S903).

Whether a machine learning model exists is checked (S904), the learning model is generated in response to non-existence of the machine learning model (S905), and the machine learning is performed in response to existence of the machine learning model (S906).

Subsequently, prediction (S907), evaluation (S908), and storage of the machine learning prediction data (S904) are performed.

The data is transmitted through the real-time machine learning predictor (S910) to the machine learning engine manager (S911), and the existence of a new version of the machine learning prediction model and logic is checked (S912).

In response to existence of the new version of the machine learning prediction model and logic, the machine learning prediction model and logic are transmitted to the smart device (S913).

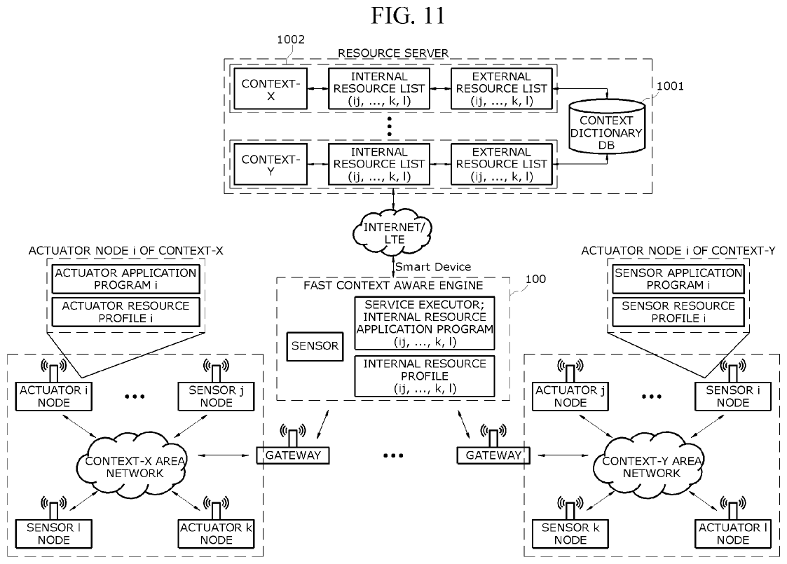

FIG. 11 is a block diagram illustrating resource discovery and application program deployment of a smart device according to an embodiment of the present invention.

A resource server manages a context directory DB 1001 and a context-specific resource list 1002.

The context directory DB 1001 includes modeling information about all individual resources of smart device internal resources and smart device external resources.

The context-specific resource list 1002 has a table regarding an internal resource list and an external resource list for recognizing a specific situation, and the modeling information of the internal and external individual resources is mapped from the context directory DB 1001.

For example, the resource server has a smart device internal resource list (i, j, . . . , k, and l) and a smart device external resource list (i, j, . . . , k, and l) required for recognizing a Context-X situation in the form of a table. Modeling information of the smart device internal resource list (i, j, . . . , k, and l) and the smart device external resource list (i, j, . . . , k, and l) is mapped from the context directory DB 1001.

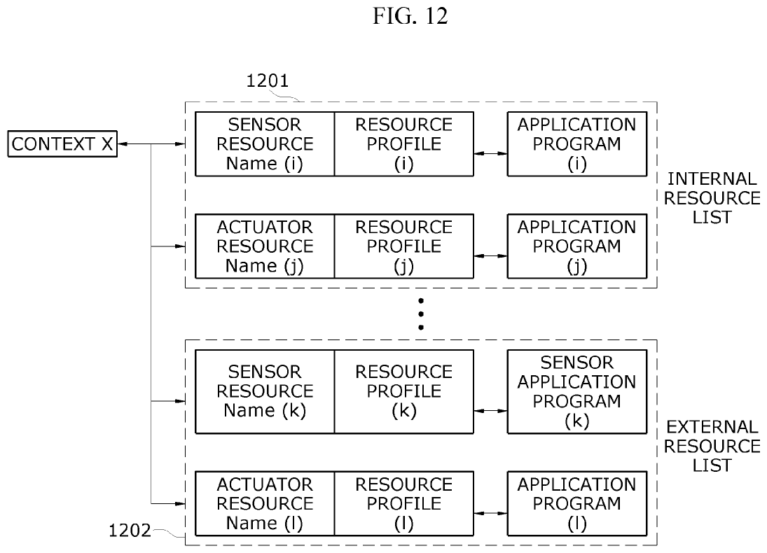

FIG. 12 is a diagram illustrating details of a resource list required for context awareness according to an embodiment of the present invention.

An internal resource list 1201 or an external resource list 1202 for recognizing a situation of a Context-X (1100) is divided into a case for a sensor or a case for an actuator and, in the case for the sensor (i), includes a sensor resource name (i), a resource property (i), and an application program (i).

In the case of the actuator (j), the resource list includes an actuator resource name (j), a resource property (j), and an application program (j).

The resource name may allow a resource to be identified as a sensor or an actuator and allow a detailed name of the resource to be identified.

The resource property includes contents about Property Name, Value, Type, Unit, and Access Mode. In the case of a resource property for an illumination sensor, Property Name is illuminance, Value is an illuminance sensor value, Type is a real value, Unit is a unit of measurement of illuminance, i.e., lx, and Access Mode indicates whether read (R), write (W), or read/write (R/W) is performable, and in this case, is marked as read (R).

The sensor application program may allow an event detection condition, a report condition, a report period, and the like to be set. The actuator application program may allow a control command and a status report for an actuator to be set.

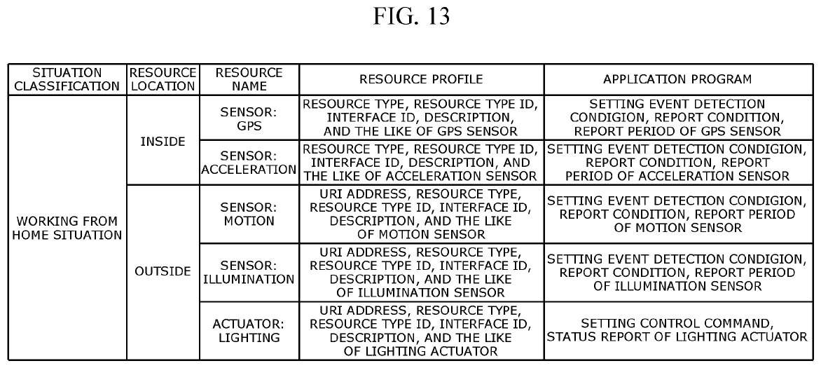

FIG. 13 illustrates an example of application of internal and external resource property and resource application program of the smart device to provide a service for automatically turning on a light around a user of the smart device, when the user is at home and the weather is cloudy.

In order to provide the service, a situation in which GPS signals are not received (i.e. in the case of a GPS shadow area) by a GPS and frequent static activity is primarily detected by an acceleration sensor built in the smart device, and thus it is determined that the current location of the user is highly likely to be the inside of a house.

In order to check whether the location of the user is the inside of a house, a resource discovery procedure with respect to a motion sensor for identifying the user's location, an illumination sensor for measuring the user's ambient illumination, and a lighting actuator for controlling a light is performed.

As a result of completion of all of the procedures, it is checked that the user of the smart device is in the house, and when it is determined that the user of the smart device is in the house and the weather is cloudy using the motion sensor and the illumination sensor, a light adjacent to the user is turned on by operating a lighting actuator.

In order to process the above described series of processes, the resource property and the application program shown in FIG. 12 need to be managed in the resource server.

For example, in the case of a GPS among the internal resources of the smart device, the internal resource is accessed using resource property information “Property Name, Value, Type, Unit, Access Mode, and the like for a GPS sensor,” and the operation of the GPS is set using application program information “event detection condition, reporting condition, reporting period, and the like for the GPS operation.”

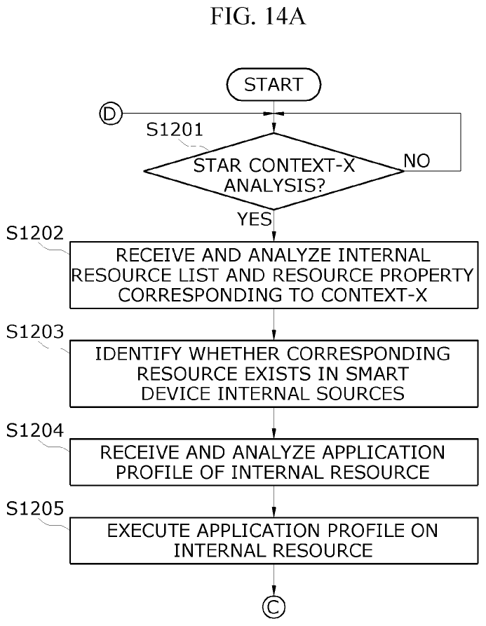

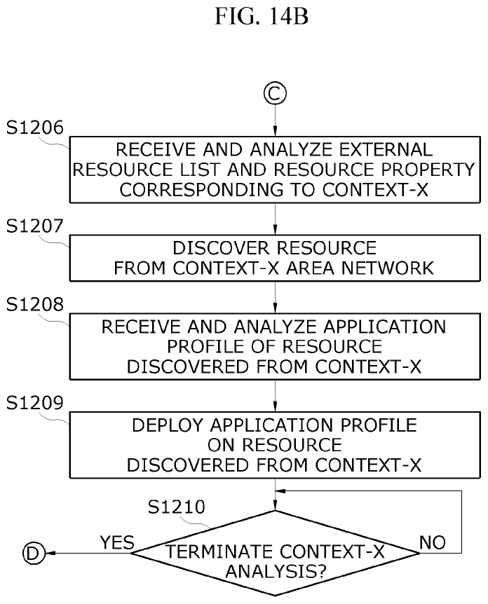

FIG. 14A and FIG. 14B illustrate data flowcharts of a smart device according to an embodiment of the present invention.

The fast context aware engine 100 of the smart device, in order to recognize a specific situation, may download and receive a smart device internal resource list (i, j, . . . , k, and l) and a smart device external resource list (i, j, . . . , k, and l) for the corresponding situation from the resource server.

A property of the resource is analyzed, an application program for the resource is executed to autonomously collect sensing information, and the sensing information is transmitted to the machine learning analyzer 103 of the fast context aware engine 100.

Referring to FIG. 14A and FIG. 14B, for example, when a Context-X analysis is started (S1201), the smart device downloads a smart device internal resource list (i, j, . . . , k, and l) from the resource server for recognition of a situation of Context-X context and analyzes a property of the corresponding resource (S1202).

Subsequently, whether a resource list corresponding to the inside of the smart device exists is identified (S1203).

An application program of the identified resource is received through download from the resource server and is analyzed (S1204), and sensing information is collected by executing the application program and is transferred to the machine learning analyzer of the fast context aware engine 100 (S1205).

After the action on the internal resources is completed, the smart device downloads an external resource list (i, j, . . . , k, and l) corresponding to Context-X from the resource server, analyzes a property of the corresponding resource (S1206), and discovers whether a resource list corresponding to the outside of the smart device exists using a multicast protocol on a Context-X Area Network (S1207).

The smart device receives an application program of the identified resource through download from the context directory server, analyzes the application program (S1208), and deploys the application program on the identified individual resource to transmit external sensing information and actuator information to the machine learning analyzer of the fast context aware engine 100 (S1209).

According to the embodiment of the present invention, the resource discovery is performed on resources in a plurality of networks, and the application program deployment is also performed via a plurality of networks.

That is, the Context-X Area Network is a virtual network that may include a plurality of networks for recognizing a Context-X and is executed through a plurality of personal area networks, such as Bluetooth low energy (BLE), WiFi, ZigBee, and the like.

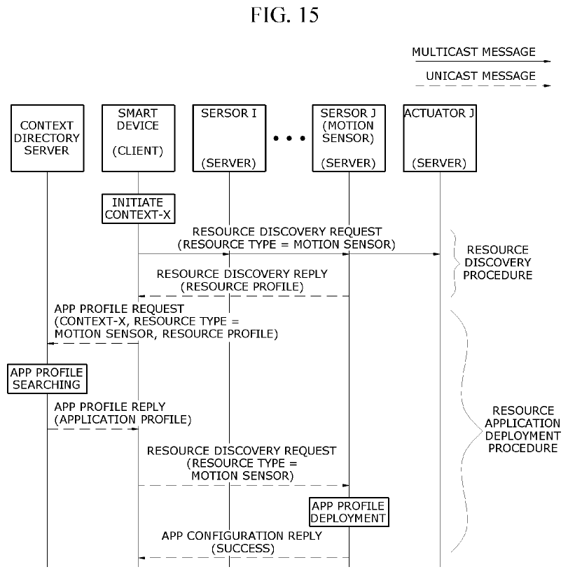

FIG. 15 illustrates a sequence diagram of resource discovery and application program deployment with respect to an external resource according to an embodiment of the present invention.

Referring to FIG. 15, for example, when Context-X analysis is started, the smart device multicasts a Resource Discovery Request (Resource Type=Motion Sensor) message on a Context-X Area Network to discover a resource for a motion sensor. Upon receiving the message, the motion sensor transmits a Resource Discovery Reply (Resource Profile) message in reply to the smart device.

The smart device requests an application profile for the discovered motion sensor from a context directory server using an App Profile Request (Context-x, Resource Type=Motion Sensor, Resource Profile) Unicast Message.

The context directory server searches for and finds an application profile that matches with the motion sensor in a context directory DB and transmits an App Profile Reply (Application Profile) Unicast message in reply to the smart device.

The smart device delivers the received application profile to the motion sensor through an App Configuration Request (Application Profile) Unicast Message.

The motion sensor replies to the smart device that deployment of an application service has succeeded using the received Application Profile through an App Configuration Reply (Success) Unicast Message.

As is apparent from the above, a fast context aware service considering dynamic context information of a user can be provided using machine learning, and the accuracy in providing a fine context aware service requiring a large amount of information and circumstances can be increased using an ontology, so that a hierarchical context aware service optimized for the user can be provided.

The fast context aware engine according to the present invention autonomously reconfigures an operating environment by recognizing a surrounding environment, such as a wearable device, an IoE device, or the like equipped with a sensor, by itself so as to recognize dynamic context information of the user in real time, thereby providing the operating environment that can be connected for itself regardless of time and place.

The fine context aware engine according to the present invention can perform knowledgebase modeling including a user's intention and a surrounding circumstance by receiving a result of the dynamic context information of the user analyzed by the smart device, perform a high-level inference using a machine learning analysis and predicted result on a user's log or history, and provide more abundant knowledgebase data by generating a new context rule using knowledgebase data of the fine context aware engine.

The fine context aware engine according to the present invention transmits a learning model or a service logic, which is available for future prediction, according to the machine learning prediction result to the smart device such that the fast context aware engine of the smart device receives the predicted learning model or service logic in advance so that the context aware service can be provided in a more rapid manner.

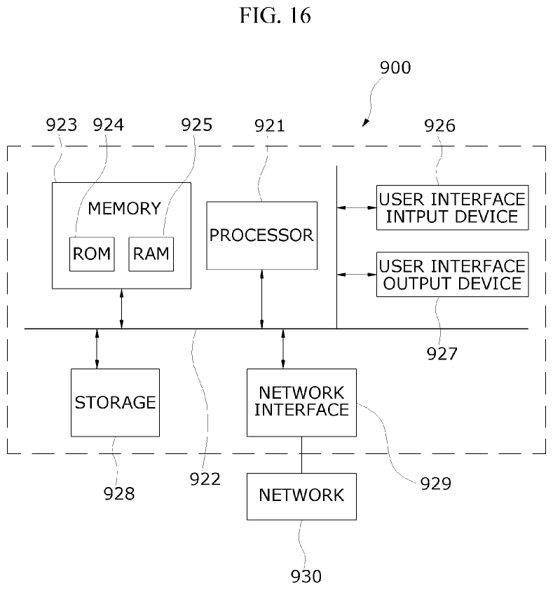

The method according to an embodiment of the present invention may be implemented in a computer system or may be recorded in a recording medium. FIG. 16 illustrates a simple embodiment of a computer system. As illustrated, the computer system may include one or more processors 921, a memory 923, a user input device 926, a data communication bus 922, a user output device 927, a storage 928, and the like. These components perform data communication through the data communication bus 922.

Also, the computer system may further include a network interface 929 coupled to a network. The processor 921 may be a central processing unit (CPU) or a semiconductor device that processes a command stored in the memory 923 and/or the storage 928.

The memory 923 and the storage 928 may include various types of volatile or non-volatile storage mediums. For example, the memory 923 may include a ROM 924 and a RAM 925.

Thus, the method according to an embodiment of the present invention may be implemented as a method that can be executable in the computer system. When the method according to an embodiment of the present invention is performed in the computer system, computer-readable commands may perform the producing method according to the present invention.

The method according to the present invention may also be embodied as computer-readable codes on a computer-readable recording medium. The computer-readable recording medium is any data storage device that may store data which may be thereafter read by a computer system. Examples of the computer-readable recording medium include read-only memory (ROM), random access memory (RAM), CD-ROMs, magnetic tapes, floppy disks, and optical data storage devices. The computer-readable recording medium may also be distributed over network coupled computer systems so that the computer-readable code may be stored and executed in a distributed fashion.

The technical objectives of the present invention are not limited to the above, and other objectives may become apparent to those of ordinary skill in the art based on the specification.

Although the present invention has been described with reference to the embodiments, a person of ordinary skill in the art should appreciate that various modifications, equivalents, and other embodiments are possible without departing from the scope and sprit of the present invention. Therefore, the embodiments disclosed above should be construed as being illustrative rather than limiting the present invention. The scope of the present invention is not defined by the above embodiments but by the appended claims of the present invention, and the present invention is to cover all modifications, equivalents, and alternatives falling within the spirit and scope of the present invention.

What is claimed is:

1. An apparatus for hierarchical context awareness and device autonomous configuration through a real-time user behavior analysis, the apparatus comprising:
a fast context aware engine configured to receive user data, infer a context, and provide a primary response context aware service; and
a fine context aware engine configured to provide a secondary response context aware service using context information inferred by the fast context aware engine and machine learning prediction data,
wherein the fast context aware engine reconfigures a resource of a smart device to suit a service.

2. The apparatus of claim 1, wherein the fast context aware engine receives sensing data from the smart device and a wearable device and uses a machine learning model received from the fine context aware engine so as to generate a fast context.

3. The apparatus of claim 2, wherein the fast context aware engine periodically transmits the fast context to the fine context aware engine.

4. The apparatus of claim 2, wherein the fast context aware engine monitors whether an event occurs according to the fast context and a service profile, and in response to sensing an event, provides the primary response context aware service in real time through the smart device.

5. The apparatus of claim 1, wherein the fine context aware engine provides the secondary response context aware service using context information generated by the fast context aware engine, Internet of Things (IoT) sensing data, external data, and the machine learning prediction data.

6. The apparatus of claim 5, wherein the fine context aware engine performs an inference by an ontology method using a knowledgebase including domain information and a context ontology.

7. The apparatus of claim 6, wherein the fine context aware engine receives data of the knowledgebase as an input of a machine learning engine in consideration of a knowledge-based context aware rule used in a semantic reasoner and generates the machine learning prediction data.

8. The apparatus of claim 5, wherein the fine context aware engine, after performing semantic knowledge inference, provides the secondary response context aware service to a service target suitable for a service profile.

9. The apparatus of claim 5, wherein the fine context aware engine generates and tests a machine learning model using the IoT sensing data and the external data and transmits a new-version learning model to the smart device at a time of update of an existing learning model stored in the smart device.

10. The apparatus of claim 9, wherein the fast context aware engine downloads and receives a list of internal resources of the smart device from a resource server and executes an application program according to a result of an analysis of a property of the internal resources so as to collect sensing information, downloads and receives a list of external resources from the resource server, analyzes a property of the external resources, performs a discovery on a list of resources corresponding to an outside of the smart device, and deploys an application program on an individual resource having been subjected to the discovery so as to collect external sensing information.
